(19) United States
(12) Patent Application Publication
(10) Pub. No.: US 2004/0266643 A1
(43) Pub. Date: Dec. 30, 2004

(54) Fabric article treatment composition for use in a lipophilic fluid system

(75) Inventors: Robb Richard Gardner, Cincinnati, OH (US); William Michael Scheper, Guilford, IN (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/876,181

(22) Filed: Jun. 24, 2004

Related U.S. Application Data
(60) Provisional application No. 60/483,346, filed on Jun. 27, 2003.

(51) Int. Cl. C11D 1/00

(52) U.S. Cl. 510/337

(57) ABSTRACT

A fabric article treatment composition comprising a polar solvent and a hydrophobic surfactant, wherein the composition is miscible in a lipophilic fluid is provided.

### CROSS REFERENCE TO RELATED APPLICATIONS

This application claims the benefit of U.S. Provisional Application Ser. No. 60/483,346, filed on Jun. 27, 2003.

### FIELD OF THE INVENTION

The present invention relates to a fabric article treatment composition, more particularly a fabric article treatment composition suitable for use in a lipophilic fluid-based fabric article treating system and methods for using the fabric article treatment composition.

### BACKGROUND OF THE INVENTION

Conventional water-based fabric article treating systems have utilized hydrophilic pretreating compositions that are effective at removing and/or reducing hydrophilic stains.

Conventional dry cleaning systems have utilized hydrophobic pretreating compositions that are effective at removing and/or reducing hydrophobic stains.

Recently, formulators have been exploring lipophilic fluid-based fabric article treating systems. Removal of hydrophilic stains in such lipophilic fluid-based systems has been a challenge. Accordingly, there is a need for a fabric article treatment composition that is effective at removing hydrophilic stains from fabric articles wherein the fabric articles are then subjected to a lipophilic fluid-based fabric article treating system.

### SUMMARY OF THE INVENTION

The present invention fulfills the need described above by providing a fabric article treatment composition that is miscible in a lipophilic fluid.

In one aspect of the present invention, a fabric article treatment composition comprising:

a) a polar solvent exhibiting at least one of the following Hansen solubility parameters:

i) a fractional polar value (f_{P}) of greater than 0.02; and/or

ii) a fractional hydrogen bonding value (f_{H}) of greater than 0.10; and

b) a hydrophobic surfactant;

wherein the fabric article treatment composition is miscible in a lipophilic fluid, is provided.

In another aspect of the present invention, an article of manufacture comprising:

a) a container; and

b) a fabric article treatment composition according to the present invention contained within the container, is provided.

In still another aspect of the present invention, a method for removing a hydrophilic stain from a fabric article in need of treatment, the method comprising contacting the hydrophilic stain with a fabric article treatment composition that is miscible in a lipophilic fluid to form a pretreated fabric article, is provided.

In yet another aspect of the present invention, a fabric article treated by a method in according to the present invention, is provided.

Accordingly, the present invention provides a fabric article treatment composition, an article of manufacture comprising the fabric article treatment composition, a method for treating a fabric article with the fabric article treatment composition and a fabric article treated by such a method.

### DETAILED DESCRIPTION OF THE INVENTION

Definitions

“Fabric article” as used herein is intended to mean any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

“Stain” means any undesirable substance on a fabric article that is desired to be removed. Generally, stains are found only on a portion of the article and are generated by accidental contact between the soil and the fabric article. By the term “hydrophilic stains” it is meant that the stain is comprised of water at the time it first came in contact with the fabric article, or the stain retains a significant portion of water on the fabric article. Examples of hydrophilic stains include, but are not limited to, beverages, many food soils, water soluble dyes, bodily fluids such as sweat, urine or blood, outdoor soils such as grass stains and mud.

“Miscible” as used herein means that greater than 5% and/or greater than 20% and/or greater than 50% by weight of a material is soluble in and/or dispersible in another material. For example that greater than 5% by weight of the fabric article treatment composition of the present invention is soluble in and/or dispersible in a lipophilic fluid.

“Pretreated fabric article” as used herein means a fabric article that has been contacted with a fabric article treatment composition of the present invention prior to subsequent contact with a discrete lipophilic fluid.

“Discrete lipophilic fluid” as used herein means a lipophilic fluid that is not part of the neat fabric article treatment composition. Typically, the discrete lipophilic fluid when combined with the fabric article treatment composition makes up greater than 30% and/or greater than 50% and/or greater than 70% by weight of the fabric article treatment composition. Notwithstanding the above, a lipophilic fluid can be present in a neat fabric article treatment composition (such as in a product that a consumer purchases and uses to contact a stain on a fabric article in a pretreating step prior to subjecting the pretreated fabric article to a fabric article treating process, such as a lipophilic fluid-based system).

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

Fabric Article Treatment Composition

The fabric article treatment composition comprises a polar solvent and a hydrophobic surfactant, wherein the fabric article treatment composition is miscible in a lipophilic fluid.

In one embodiment, the fabric article treatment composition comprises from about 10% to about 99.9% and/or from about 20% to about 95% and/or from about 30% to about 90% by weight of the fabric article treatment of the polar solvent.

In another embodiment, the fabric article treatment composition comprises from about 0.1% to about 90% and/or from about 5% to about 80% and/or from about 10% to about 80% and/or from about 10% to about 30% by weight of the fabric article treatment composition of the hydrophobic surfactant.

In still another embodiment, the fabric article treatment composition comprises the polar solvent and the hydrophobic surfactant at a weight ratio of polar solvent to hydrophobic surfactant of from about 10:1 to about 1:10 and/or from about 10:1 to about 1:5 and/or from about 5:1 to about 1:1.

In yet another embodiment, the fabric article treatment composition has a flash point of greater than 37° C. and/or greater than 50° C.

In one embodiment, a neat fabric article treatment composition, such as that contained in a container or some other delivery device prior to contacting the fabric comprises:

a. from about 5% to about 99.9% and/or from about 10% to about 40% by weight of the fabric article treatment composition of a polar solvent; and

b. from about 0.1% to about 90% and/or from about 10% to about 40% by weight of the fabric article treatment composition of a hydrophobic surfactant.

In another embodiment, a fabric article treatment composition, in use, such as when the pretreated fabric article is contacted with a discrete lipophilic fluid, comprises:

a. from about 1% to about 99% and/or from about 5% to about 40% by weight of the fabric article treatment composition of a polar solvent;

b. from about 0.1% to about 90% and/or from about 5% to about 40% by weight of the fabric article treatment composition of a hydrophobic surfactant; and

c. from about 0.1% to about 95% and/or from about 5% to about 50% by weight of the fabric article treatment composition of a lipophilic fluid.

In other embodiments, the fabric article treatment composition comprises a polar solvent and a hydrophobic surfactant at a ratio of polar solvent to hydrophobic surfactant of from about 20:1 to about 1:20 and/or from about 10:1 to about 1:10.

Preferred fabric article treatment composition suitable for use herein can further be qualified for use on the basis of having an excellent garment care profile. Garment care profile testing is well known in the art and involves testing a composition to be qualified using a wide range of garment or fabric article components, including fabrics, threads and elastics used in seams, etc., and a range of buttons. Preferred fabric article treatment compositions for use herein have an excellent garment care profile, for example they have a good shrinkage or fabric puckering profile.

A. Polar Solvent

The polar solvents according to the present invention exhibit at least one of the following Hansen solubility parameters:

a fractional polar value (f_{P}) of greater than 0.02 and/or greater than 0.05; and/or

a fractional hydrogen bonding value (f_{H}) of greater than 0.10 and/or greater than 0.2.

Nonlimiting examples of polar solvents suitable for use in the fabric article treatment composition of the present invention include: water, alcohols, glycols, polyglycols, ethers, carbonates, dibasic esters, ketones, other oxygenated solvents, and mixtures thereof. Further examples of alcohols include: C1-C126 alcohols, such as propanol, ethanol, isopropyl alcohol, etc . . . , benzyl alcohol, and diols such as 1,2-hexanediol. The Dowanol series by Dow Chemical are examples of glycols and polyglycols useful in the present invention, such as Dowanol TPM, TPnP, DPNB, DPnP, TPnB, PPh, DPM, DPMA, DB, and others. Further examples include propylene glycol, butylene glycol, polybutylene glycol and more hydrophobic glycols. Examples of carbonate solvents are ethylene, propylene and butylene carbonates such as those available under the Jeffsol tradename. Polar solvents for the present invention can be further identified through their dispersive (δ_{D}), polar (δ_{P}) and hydrogen bonding (δ_{H}) Hansen solubility parameters. Preferred polar solvents or polar solvent mixtures have fractional polar (f_{P}) and fractional hydrogen bonding (f_{H}) values of f_{P}>0.02 and f_{H}>0.10, where f_{P}=δ_{P}/(δ_{D}+δ_{P}δ_{H}) and f_{H}=δ_{H}/(δ_{D}+δ_{P}+δ_{H}), more preferably f_{P}>0.05 and f_{H>}0.20, and most preferably f_{P}>0.07 and f_{H}>0.30.

In one embodiment, the polar solvent is selected from the group consisting of: water, alcohols, glycols, polyglycols, ethers, carbonates, esters, ketones, other oxygenated solvents, amines, amides, ureas, alkanolamines, alkanolamides phosphate esters, alkyl nitriles and mixtures thereof.

In one embodiment, the polar solvent comprises from about 0% to about 50% and/or from about 0.01 to about 20% by weight of water

B. Hydrophobic Surfactant

“Hydrophobic surfactant” conventionally refers to materials that are surface-active either in the water, the lipophilic fluid, or a mixture of the two. Some illustrative surfactants include nonionic, cationic and silicone surfactants as used in conventional aqueous detergent systems.

Suitable nonionic surfactants include, but are not limited to:

a) Polyethylene oxide condensates of nonyl phenol and myristyl alcohol, such as in U.S. Pat. No. 4,685,930 Kasprzak; and

b) fatty alcohol ethoxylates, R—(OCH₂CH₂)ₐOH a=1 to 100, typically 1240, R=hydrocarbon residue 8 to 20 C atoms, typically linear alkyl. Examples polyoxyethylene lauryl ether, with 4 or 23 oxyethylene groups; polyoxyethylene cetyl ether with 2, 10 or 20 oxyethylene groups; polyoxyethylene stearyl ether, with 2, 10, 20, 21 or 100 oxyethylene groups; polyoxyethylene (2), (10) oleyl ether, with 2 or 10 oxyethylene groups. Commercially available examples include, but are not limited to: ALFONIC, BRIJ, GENAPOL, NEODOL, SURFONIC, TRYCOL. See also U.S. Pat. No. 6,013,683 Hill et al.,.

Suitable cationic surfactants include, but are not limited to dialkyldimethylammonium salts having the formula:

R′R″N⁺(CH₃)₂X⁻

where each R′R″ is independently selected from the group consisting of 12-30 C atoms or derived from tallow, coconut oil or soy, X=Cl or Br, Examples include: didodecyldimethylammonium bromide (DDAB), dihexadecyldimethyl ammonium chloride, dihexadecyldimethyl ammonium bromide, dioctadecyldimethyl ammonium chloride, dieicosyldimethyl ammonium chloride, didocosyldimethyl ammonium chloride, dicoconutdimethyl ammonium chloride, ditallowdimethyl ammonium bromide (DTAB). Commercially available examples include, but are not limited to: ADOGEN, ARQUAD, TOMAH, VARIQUAT. See also U.S. Pat. No. 6,013,683 Hill et al.

Nonlimiting examples of hydrophobic surfactants suitable for use in the present invention include structure having the following general formulas:

Yᵤ-(Lₜ-Xᵥ)ₓ—Y′_{w} (I)

L_{y}-(Xᵥ—Yᵤ)ₓ-L′_{z} (II)

and mixtures thereof;

wherein L and L′ are solvent compatibilizing (or lipophilic) moieties, which are independently selected from:

(a) C1-C22 alkyl or C4-C12 alkoxy, linear or branched, cyclic or acyclic, saturated or unsaturated, substituted or unsubstituted;

(b) siloxanes having the formula:

MₐD_{b}D′_{c}D″_{d}

wherein a is 0-2; b is 0-1000; c is 0-50; d is 0-50, provided that a+c+d is at least 1;

M is R¹₃₋ₑXₑSiO_{1/2} wherein R¹ is independently H, or an alkyl group, X is hydroxyl group, and e is 0 or 1;

D is R⁴₂SiO_{2/2}, wherein R⁴ is independently H or an alkyl group;

D′ is R⁵₂SiO_{2/2} wherein R⁵ is independently H, an alkyl group or (CH₂)_{f}(C₆Q₄)_{g}O—(C₂H₄O)ₕ—(C₃H₆O)ᵢ(CₖH₂ₖ)ⱼ—R³, provided that at least one R⁵ is (CH₂)_{f}(C₆Q₄)_{g}O—(C₂H₄O)ₕ—(C₃H₆O)ᵢ(CₖH₂ₖ)ⱼ—R³, wherein R³ is independently H, an alkyl group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₂₋₁₀ alkenyl, and mixtures thereof; and

D″ is R⁶₂SiO_{2/2} wherein R⁶ is independently H, an alkyl group or (CH₂)ₗ(C₆Q₄)ₘ(A)ₙ-[(T)ₒ-(A′)ₚ-]_{q}-(T′)ᵣZ(G)ₛ, wherein I is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₂₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; T and T′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate; and D″ can be capped with C₁-C₄ alkyl or hydroxy groups;

Y and Y′ are hydrophilic moieties, which are independently selected from hydroxy; polyhydroxy; C1-C3 alkoxy; mono- or di-alkanolamine; C1-C4 alkyl substituted alkanolamine; substituted heterocyclic containing O, S, N; sulfates; carboxylate; carbonate; and when Y and/or Y′ is ethoxy (EO) or propoxy (PO), it must be capped with R, which is selected from the group consisting of:

(i) a 4 to 8 membered, substituted or unsubstituted, heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

X is a bridging linkage selected from 0; S; N; P; C1 to C22 alkyl, linear or branched, saturated or unsaturated, substituted or unsubstituted, cyclic or acyclic, aliphatic or aromatic, interrupted by O, S, N, P; glycidyl, ester, amido, amino, PO₄²⁻, HPO₄⁻, PO₃²⁻, HPO₃⁻, which are protonated or unprotonated;

u and w are integers independently selected from 0 to 20, provided that u+w>1;

t is an integer from 1 to 10;

v is an integer from 0 to 10;

x is an integer from 1 to 20; and

y and z are integers independently selected from 1 to 10.

Nonlimiting examples of surfactants having the above formula include:

(1) alkanolamines/alkanolamides;

(2) phophate/phosphonate esters;

(3) gemini surfactants including, but are not limited to, gemini diols, gemini amide alkoxylates, gemini amino alkoxylates;

(4) capped nonionic surfactants;

(5) capped silicone surfactants such as nonionic silicone ethoxylates, silicone amine derivatives;

(6) alkyl alkoxylates;

(7) polyol surfactants; and

(8) mixtures thereof.

Another class of surfactants can include siloxane-based surfactants. The siloxane-based surfactants in this application may be siloxane polymers for other applications. The siloxane-based surfactants typically have a weight average molecular weight from 500 to 20,000 daltons. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula:

MₐD_{b}D′_{c}D″_{d}M′₂₋ₐ

wherein a is 0-2; b is 0-1000; c is 0-50; d is 0-50, provided that a+c+d is at least 1;

M is R¹₃₋ₑXₑSiO_{1/2} wherein R¹ is independently H or an alkyl group, X is hydroxyl group, and e is 0 or 1;

M′ is R²₃SiO_{1/2} wherein R² is independently H, an alkyl group, or (CH₂)_{f}(C₆Q₄)_{g}O—(C₂H₄O)ₕ—(C₃H₆₀)ᵢ(CₖH₂ₖ)ⱼ—R³, provided that at least one R² is (CH₂)_{f}(C6Q₄)_{g}O—(C₂H₄O)ₕ—(C₃H₆O)ᵢ(CₖH₂ₖ)ⱼ—R³, wherein R³ is independently H, an alkyl group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₁₋₁₀ alkenyl, and mixtures thereof;

D is R⁴₂SiO_{2/2}, wherein R⁴ is independently H or an alkyl group;

D′ is R⁵₂SiO_{2/2} wherein R⁵ is independently H, an alkyl group, or (CH₂)_{f}(C₆Q₄)_{g}O—(C₂H₄O)ₕ—(C₃H₆₀)ᵢ(CₖH₂ₖ)ⱼ—R³, provided that at least one R⁵ is (CH₂)_{f}(C6Q₄)_{g}O—(C₂H₄O)ₕ—(C₃H₆₀)ᵢ(CₖH₂ₖ)ⱼ—R³, wherein R³ is independently H, an alkyl group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₁₋₁₀ alkenyl, and mixtures thereof; and

D″ is R⁶₂SiO_{2/2} wherein R⁶ is independently H, an alkyl group or (CH₂)ₗ(C₆Q₄)ₘ(A)ₙ-[(T)ₒ-(A′)ₚ-]_{q}-(T′)ᵣZ(G)ₛ, wherein I is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₁₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; T and T′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443A1, EP-1,041,189 and WO-01/34,706 (all to GE Silicones) and U.S. Pat. No. 5,676,705, U.S. Pat. No. 5,683,977, U.S. Pat. No. 5,683,473, and EP-1,092,803A1 (all assigned to Lever Brothers).

Nonlimiting commercially available examples of suitable siloxane-based surfactants are TSF 4446 (ex. General Electric Silicones), XS69-B5476 (ex. General Electric Silicones); Jenamine HSX (ex. DelCon) and Y12147 (ex. OSi Specialties).

Yet another class of materials suitable for the surfactant component is organic in nature. Preferred materials are organosulfosuccinate surfactants, with carbon chains of from about 6 to about 20 carbon atoms. Most preferred are organosulfosuccinates containing dialkly chains, each with carbon chains of from about 6 to about 20 carbon atoms. Also preferred are chains containing aryl or alkyl aryl, substituted or unsubstituted, branched or linear, saturated or unsaturated groups. Nonlimiting commercially available examples of suitable organosulfosuccinate surfactants are available under the trade names of Aerosol OT and Aerosol TR-70 (ex. Cytec).

Suitable silicone surfactants include, but are not limited to the polyalkyleneoxide polysiloxanes having a dimethyl polysiloxane hydrophobic moiety and one or more hydrophilic polyalkylene side chains and have the general formula:

R¹—(CH₃)₂SiO—[(CH₃)₂SiO]ₐ—[(CH₃)(R¹)SiO]_{b}—Si(CH₃)₂—R¹

wherein a+b are from about 1 to about 50, preferably from about 3 to about 30, more preferably from about 10 to about 25, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, preferably 3; total c (for all polyalkyleneoxy side groups) has a value of from 1 to about 100, preferably from about 6 to about 100; total d is from 0 to about 14, preferably from 0 to about 3; and more preferably d is 0; total c+d has a value of from about 5 to about 150, preferably from about 9 to about 100 and each R² is the same or different and is selected from the group consisting of hydrogen, an alkyl having 1 to 4 carbon atoms, and an acetyl group, preferably hydrogen and methyl group. Examples of these surfactants may be found in U.S. Pat. No. 5,705,562 Hill and U.S. Pat. No. 5,707,613 Hill, both of which are incorporated herein by reference.

Examples of this type of surfactants are the Silwet® surfactants which are available CK Witco, OSi Division, Danbury, Conn. Representative Silwet® surfactants are as follows.

| Name | Average MW | Average a + b | Average total c |
|---|---|---|---|
| L-7608 | 600 | 1 | 9 |
| L-7607 | 1,000 | 2 | 17 |
| L-77 | 600 | 1 | 9 |
| L-7605 | 6,000 | 20 | 99 |
| L-7604 | 4,000 | 21 | 53 |
| L-7600 | 4,000 | 11 | 68 |
| L-7657 | 5,000 | 20 | 76 |
| L-7602 | 3,000 | 20 | 29 |

The molecular weight of the polyalkyleneoxy group (R¹) is less than or equal to about 10,000. Preferably, the molecular weight of the polyalkyleneoxy group is less than or equal to about 8,000, and most preferably ranges from about 300 to about 5,000. Thus, the values of c and d can be those numbers which provide molecular weights within these ranges. However, the number of ethyleneoxy units (C₂H₄O) in the polyether chain (R¹) must be sufficient to render the polyalkyleneoxide polysiloxane water dispersible or water soluble. If propyleneoxy groups are present in the polyalkylenoxy chain, they can be distributed randomly in the chain or exist as blocks. Preferred Silwet® surfactants are L-7600, L-7602, L-7604, L-7605, L-7657, and mixtures thereof. Besides surface activity, polyalkyleneoxide polysiloxane surfactants can also provide other benefits, such as antistatic benefits, and softness to fabric articles.

The preparation of polyalkyleneoxide polysiloxanes is well known in the art. Polyalkyleneoxide polysiloxanes of the present invention can be prepared according to the procedure set forth in U.S. Pat. No. 3,299,112.

Another suitable silicone surfactant is SF-1488, which is available from GE silicone fluids.

These and other surfactants suitable for use in combination with the lipophilic fluid as adjuncts are well known in the art, being described in more detail in Kirk Othmer's Encyclopedia of Chemical Technology, 3rd Ed., Vol. 22, pp. 360-379, “Surfactants and Detersive Systems”. Further suitable nonionic detergent surfactants are generally disclosed in U.S. Pat. No. 3,929,678, Laughlin et al., issued Dec. 30, 1975, at column 13, line 14 through column 16, line 6.

In one embodiment, the hydrophobic surfactant exhibits an HLB value of from about 0.1 to about 12 and/or from about 3 to about 9.

In another embodiment, the hydrophobic surfactant is selected from the group consisting of: silicone-based surfactants, organosulfosuccinate surfactants, alkanolamines, alkanolamides, alcohol alkoxylates, gemini surfactants, polyhydroxy fatty acid amides, alkylhydrogen phosphates and salts thereof, saccharide derivatives and Alkanolamine based surfactants have the ability to aid in cleaning for water soluble and water based soils. However, these functionalities typically do not have good compatibility in dry cleaning solvent such as decamethylcyclopentasiloxane.

Suitable alkanolamine surfactant would have the general formula (I) wherein the H moiety is an alkanolamine moiety having the following formula:

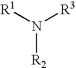

wherein R¹, R², R³ are same or different and are independently selected from H, hydrocarbons, polyoxyalkylenes, siloxanes or flurorinated groups; and at least one hydroxyl group is present in the alkanolamine moiety, either to terminate one or more R groups or be present within one or more of the R groups as a secondary hydroxyl group. Hydrocarbon groups may be linear or branched, cyclic or acyclic, saturated or unsaturated, and contain about 1-30 carbons, preferably about 6 to 30 carbons, more preferably about 8 to 18 carbons. Silicone and fluorinated groups may consist of 1-50 repeat units.

The method of functionalizing the alkanolamine moiety may be, but not limited to alkylation, esterification, etherification, amidation, amination and other linking chemistries. Thus, the corresponding bridging group Bⱼ can be alkyl, ester, ether, amido, and amino linking groups. The number and size of the solvotrope groups Sₖ used for a given alkanolamine group is important for optimized performance. When a surfactant contains too numerous and/or too large solvotrope groups, the surfactants may exhibit too high a solubility profile in the solvent or too high a molecular weight, both of which lead to ineffective cleaning and/or soil removal performance. Moreover, the surfactant may become a solid, which makes solubiliztion in the solvent and formulation difficulty. On the other hand, when the surfactant contains too few and/or too small solvotrope groups, the surfactant may exhibit poor solubility in the solvent and reduce the effectiveness of the alkanolamine moiety in cleaning and/or soil removal.

The present invention alkanolamine based surfactants may comprise one or more polyalkylene oxide units or solvatrope groups, S within the surfactant structure. The alkoxy moieties are selected from ethoxy (EO), propoxy (PO), butoxy (BO), higher alkoxy moieties, and mixtures thereof, such as mixed EO/PO, EO/B, PO/BO, EO/PO/BO, and the like, wherein the number of repeat units (m) may be 1 to 50. The alkoxy moieties may be either a distribution having an average degree of alkoxylation of m repeat units, or a monodispersed moiety with m repeat units of alkoxylation

In one embodiment of the present invention, the functionalized alkanolamine moiety has an average of at least 1 solvotrope moiety per surfactant molecule. Preferably, the surfactant molecules contains sufficient number of solvotrope moieties to rpovide solvent compatibility. In another embodiment of the invention, the alkanolamine moiety has an average of at least 2 solvent compatibility groups per alkanolamine moiety (i.e., a moiety having a “twin tail” structure). The solvotrope moiety can be selected from OH, alkoxy, and mixtures thereof.

The following are nonlimiting examples of functionalized alkanolamine containing surfactants useful in the present invention:

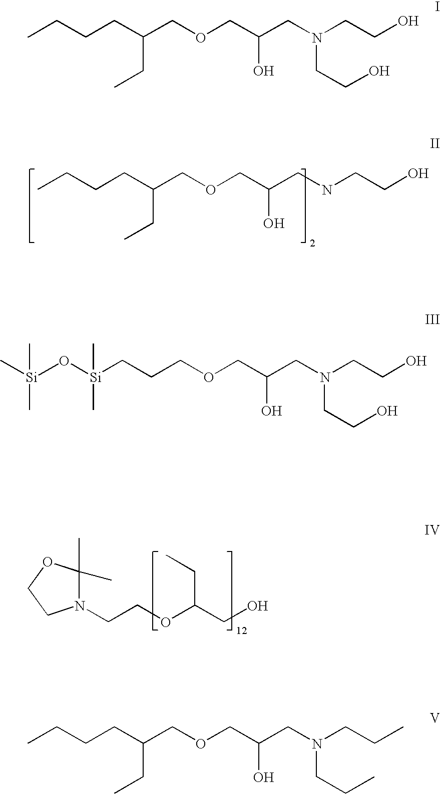

The alkanolamine based surfactants of the present invention have at least 1 free hydroxyl per molecule.

In some embodiments, the composition comprises from about 0.01 to about 10 wt % of an alkanolamine based surfactant, from about 0 to about 20 wt % of water, from about 0.1 to about 20 wt % of other detergent adjuncts, and the balance of lipophilic fluids. These cleaning compositions have been shown to enhance the overall cleaning and stain removal performance of the composition. These compositions are particularly effective in the cleaning and removing stains of blood, grass and clay.

Phosphate/phosphonate ether surfactants have the general formula (I) wherein the B moiety can be a phosphate based moiety having the following formula:

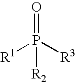

wherein R¹, R², R³ are independently selected from H, OR⁴, C₁-C₂₂ alkyl, which are linear or branched, substituted or unsubstituted, cyclic or acyclic, and optionally interrupted by O, N, S, or P; R⁴ is selected from:

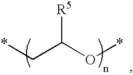

H, Na, K, L₁, C₁-C₂₂ alkyl, which are linear or branched, substituted or unsubstituted, cyclic or acyclic, and optionally interrupted by O, N, S, or P; R⁵ is selected from H, CH₃, C₂H₅, C₃H₇, C₄H₉; and n is an integer from 0 to 10.

The following are nonlimiting examples of functionalized phosphate ester containing surfactants useful in the present invention:

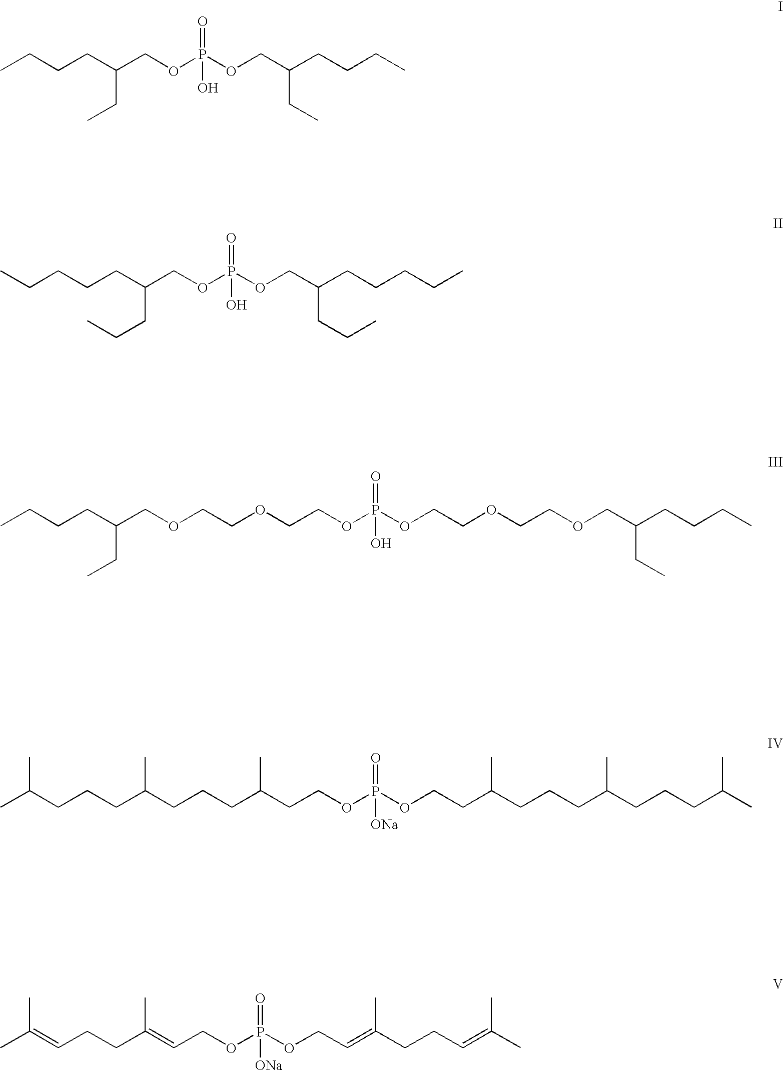

In some embodiments, the composition comprises from about 0.01 to about 10 wt % of a phosphate based surfactant, from about 0 to about 20 wt % of water, from about 0.1 to about 20 wt % of other detergent adjuncts, and the balance of lipophilic fluids. These cleaning compositions have been shown to enhance the overall cleaning and stain removal performance of the composition. These compositions are particularly effective in the cleaning and removing stains of blood, grass and tea.

Whereas the conventional surfactants generally have one hydrophilic group and one hydrophobic group, the Gemini surfactants are compounds having at least two hydrophobic groups and at least two hydrophilic groups. See J. American Chemical Soc., 115, 10083-10090 (1993); and Chemtech, March 1993, pp 30-33. Gemini surfactants have been found to be very effective emulsifiers when used at very low concentrations in comparison to conventional surfactants. This characteristic further leads to superior detergency at very low concentrations.

The following are nonlimiting examples of Gemini surfactants suitable for use in the present invention:

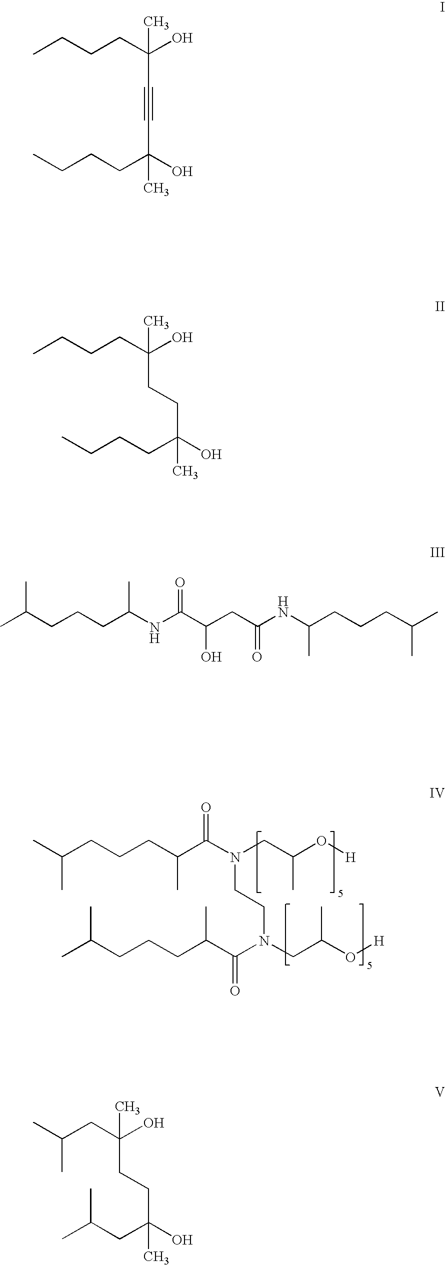

In some embodiments, the composition comprises from about 0.01 to about 10 wt % of a gemini surfactant, from about 0 to about 20 wt % of water, from about 0.1 to about 20 wt % of other detergent adjuncts, and the balance of lipophilic fluids. These cleaning compositions have been shown to enhance the overall cleaning and stain removal performance of the composition. These compositions are particularly effective in the cleaning and removing clays and make-up stains.

In one embodiment of the present invention, a capped nonionic surfactant according to formula (i) can have the general formula:

R¹O[CH₂CH(R³)O]ₓ[CH₂]ₖCH(OH)[CH₂]ⱼOₙR²

wherein R¹ and R² are linear or branched, saturated or unsaturated, aliphatic or aromatic hydrocarbon radicals having from about 1 to about 30 carbon atoms; R³ is H, or a linear aliphatic hydrocarbon radical having from about 1 to about 4 carbon atoms; x is an integer having an average value from 1 to about 40, wherein when x is 2 or greater, R³ may be the same or different and k and j are integers having an average value of from about 1 to about 12, and more preferably 1 to about 5, n is an integer from 0 to 1; further wherein when x is 15 or greater and R³ is H and methyl, at least four of R³ are methyl, further wherein when x is 15 or greater and R³ includes H and from 1 to 3 methyl groups, then at least one R³ is ethyl, propyl or butyl, further wherein R² can optionally be alkoxylated, wherein said alkoxy is selected from ethoxy, propoxy, butyloxy and mixtures thereof; wherein R¹ and R² are preferably linear or branched, saturated or unsaturated, aliphatic or aromatic hydrocarbon radicals having from about 6 to about 22 carbon atoms with about 8 to about 18 carbon atoms being most preferred. R² can optionally be alkoxylated, wherein the alkoxy is selected from ethoxy, propoxy, butyloxy and mixtures thereof. H or a linear aliphatic hydrocarbon radical having from about 1 to about 2 carbon atoms is most preferred for R³. Preferably, x is an integer having an average value of from about 1 to about 20, more preferably from about 6 to about 15. Also, preferred in the present invention are alcohol surfactants.

In another embodiment of the present invention, the capped nonionic surfactant according to formula (i) can be an ether-capped poly(oxyalkylated) alcohol surfactant, specifically, with the formula:

RO(R¹O)ₓCH(CH₃)OR²

wherein, R is selected from the group consisting of linear or branched, saturated or unsaturated, substituted or unsubstituted, aliphatic or aromatic hydrocarbon radicals having from about 1 to about 30 carbon atoms; R¹ may be the same or different, and is independently selected from the group consisting of branched or linear C₂ to C₇ alkylene in any given molecule; x is a number from 1 to about 30; and R² is selected from the group consisting of:

(iii) a 4 to 8 membered substituted, or unsubstituted heterocyclic ring containing from 1 to 3 hetero atoms; and

(iv) linear or branched, saturated or unsaturated, substituted or unsubstituted, cyclic or acyclic, aliphatic or aromatic hydrocarbon radicals having from about 1 to about 30 carbon atoms;

provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

In yet another embodiment of the present invention, the capped nonionic surfactant according to formula (i) can be an ether-capped poly(oxyalkylated) alcohols having the formula:

RO(R¹O)ₙR²

In one aspect of the present invention R is a linear or branched, saturated or unsaturated, substituted or unsubstituted, aliphatic hydrocarbon radical having from about 1 to about 20 carbon atoms, even more preferably R is a linear or branched, saturated, aliphatic hydrocarbon radicals having from about 4 to about 18 carbon atoms.

In one aspect of the present invention R, R¹ and R² are selected such that the ether-capped poly(oxyalkylated) alcohol surfactant contains one or more chiral carbon atoms.

In one aspect of the present invention, R is a hydrocarbon radical of the formula:

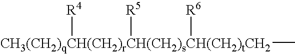

wherein R⁴, R⁵, and R⁶ are each independently selected from hydrogen, and C₁-C₃ alkyl, more preferably hydrogen, C₁-C₂ alkyl, even more preferably hydrogen, and methyl, provided that R⁴, R⁵, and R⁶ are not all hydrogen and, when t is 0, at least R⁴ or R⁵ is not hydrogen; q, r, s, t are each independently integers from 0 to 13. In one more preferred form of this aspect R is selected from the formulas:

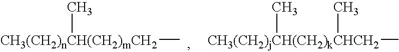

wherein n, m, j and k are each independently integers from 0 to 13.

In one aspect of the present invention R² is a hydrocarbon radical of the formula:

—C(CH₃)₂R³

R³ is selected from the group consisting of linear or branched, saturated or unsaturated, substituted or unsubstituted, aliphatic or aromatic hydrocarbon radicals having from about 1 to about 30, more preferably 1 to 20, even more preferably 1 to 15, carbon atoms, provided that when R³ is methyl, R is branched. In one embodiment of this aspect of the present invention, R³ is ethyl.

In one aspect of the present invention R² is a 4 to 8 membered substituted, or unsubstituted heterocyclic ring containing from 1 to 3 hetero atoms. In one embodiment of this aspect of the invention the hetero atoms are selected from the group comprising oxygen, nitrogen, sulfur and mixtures thereof. In one embodiment of this aspect of the invention R² is a 5 or 6 member heterocycle. In another embodiment of this aspect of the present invention R² is selected from the group consisting of:

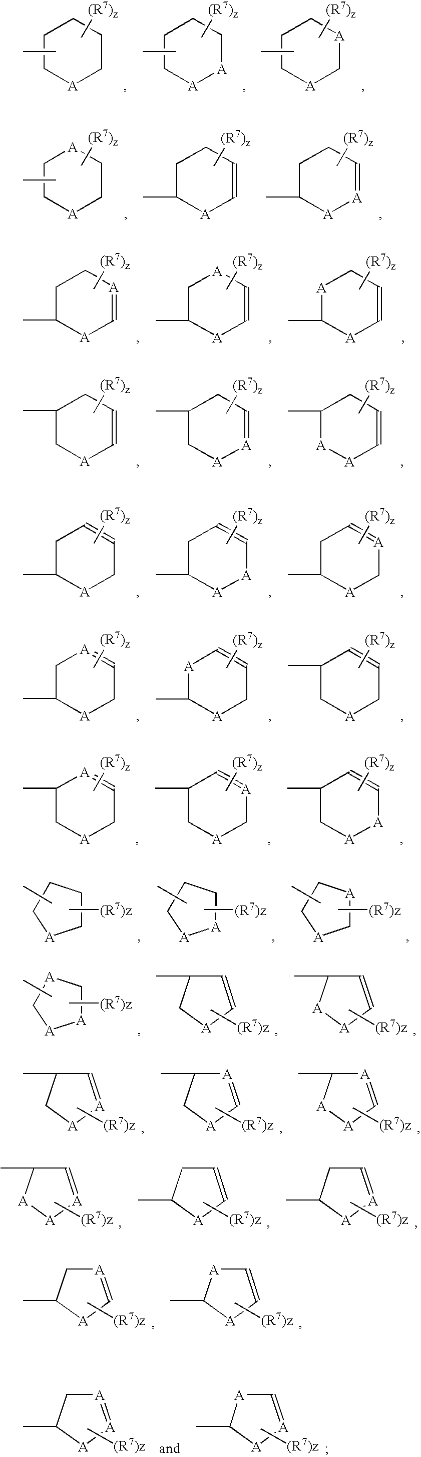

wherein each R⁷ is independently selected from the group consisting of hydrogen, linear or branched, saturated or unsaturated, substituted or unsubstituted, aliphatic hydrocarbon or alkoxy radical having from about 1 to about 10 carbon atoms, or R⁷ is a saturated or unsaturated, substituted or unsubstituted, alicyclic or aromatic hydrocarbon radical having, from about 1 to about 10 carbon atoms, which is fused to the heterocyclic ring; each A is independently selected from the group consisting of O, and N(R⁸)ₐ, wherein R⁸ is independently selected from the group consisting of hydrogen, linear or branched, saturated or unsaturated, substituted or unsubstituted, aliphatic hydrocarbon radical having from about 1 to about 10 carbon atoms, and a is either 0 or 1; z is an integer from 1 to 3.

In another embodiment of this aspect of the present invention R² is selected from the group consisting of:

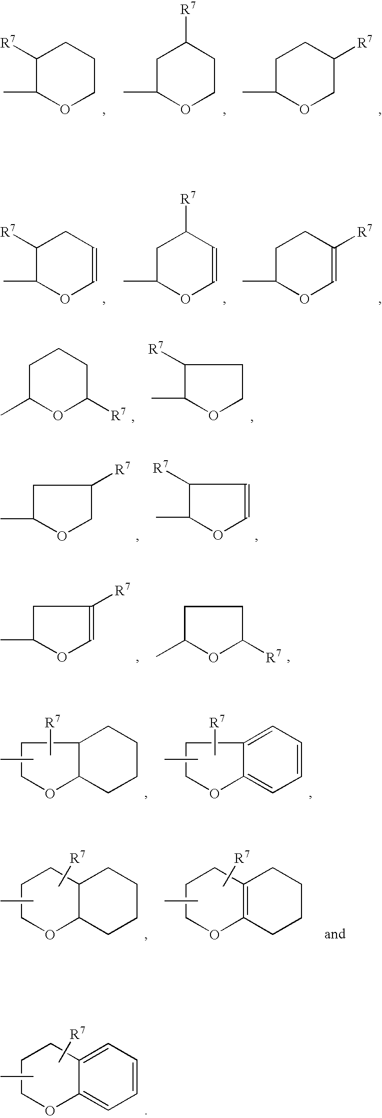

wherein R⁷ is defined as above.

The following are nonlimiting examples of capped nonionic surfactants suitable for use in the present invention:

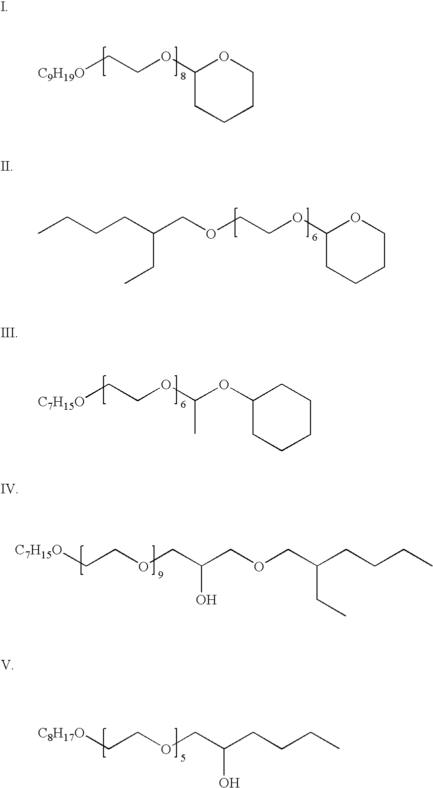

In some embodiments, the composition comprises from about 0.01 to about 10 wt % of a capped nonionic surfactant, from about 0 to about 20 wt % of water, from about 0.1 to about 20 wt % of other detergent adjuncts, and the balance of lipophilic fluids. These cleaning compositions have been shown to enhance the overall cleaning and stain removal performance of the composition. These compositions are particularly effective in the cleaning and removing stains of grass and clay.

In one embodiment of the present invention, the amide containing surfactant has a structure according to formula (i) or (ii) below:

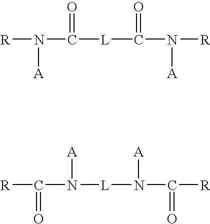

R=C₁-C₂₂ linear alkyl, alkyl substituted aromatic, C₃-C₂₂ branched alkyl, linear alkenyl, branched alkenyl, C₅-C₂₂ cyclic alkyl, cyclic alkenyl, aryl

L=C₁-C₁₂ substituted/unsubstituted alkyl, alkyl substituted aromatic, C₃-C₁₂ branched alkyl, linear alkenyl, branched alkenyl, C₅-C₁₂ cyclic alkyl, cyclic alkenyl, aryl

or −[(CR₂R₃)ₖ—X]ₘ—(CR₄R₅)ₙ—; where R₂,R₃,R₄,R₅═H, alkyl, X=O, N, k=2-6, m=0-5 & n=2-6

A=H, —(R₆O)ₙR₇; where R₆═C₂-C₄ alkylene and R₇═H or R mixtures thereof.

Another class of materials can include polyol-based surfactants. “Polyol”, as used herein, means any aliphatic or aromatic compound containing at least two free hydroxyl groups. In practicing the processes disclosed herein, the selection of a suitable polyol is simply a matter of choice. For example, suitable polyols may be selected from the following classes: saturated and unsaturated straight and branched chain linear aliphatic; saturated and unsaturated cyclic aliphatic, including heterocyclic aliphatic; or mononuclear or polynuclear aromatics, including heterocyclic aromatics. Carbohydrates and glycols are exemplary polyols. Especially preferred glycols include glycerin. Monosaccharides suitable for use herein include, for example, mannose, galactose, arabinose, xylose, ribose, apiose, rhamnose, psicose, fructose, sorbose, tagitose, ribulose, xylulose, and erythrulose. Oligosaccharides suitable for use herein include, for example, maltose, kojibiose, nigerose, cellobiose, lactose, melibiose, gentiobiose, turanose, rutinose, trehalose, sucrose and raffinose. Polysaccharides suitable for use herein include, for example, amylose, glycogen, cellulose, chitin, inulin, agarose, zylans, mannan and galactans. Although sugar alcohols are not carbohydrates in a strict sense, the naturally occurring sugar alcohols are so closely related to the carbohydrates that they are also preferred for use herein. The sugar alcohols most widely distributed in nature and suitable for use herein are sorbitol, mannitol and galactitol. Other polyols include pentaerythritol and derivatives thereof.

Particular classes of materials suitable for use herein include monosaccharides, disaccharides and sugar alcohols. Other classes of materials include sugar ethers, alkoxylated polyols, such as polyethoxy glycerol and other polyols containing amines such as glucosamine. Polyol based surfactants have the ability to aid in cleaning for water soluble and water based soils. However, these functionalities typically do not have good compatibility in dry cleaning solvent such as decamethylcyclopentasiloxane. The present invention utilizes a solvent compatibility group functionalized onto a polyol for improved cleaning.

Example of a general sucrose based structure is shown in the following structure:

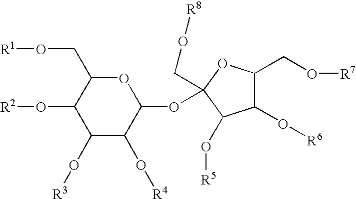

where R¹, R², R³, R⁴, R⁵, R⁶, R⁷, and R⁸ can be any combination of H, hydrocarbon, polyoxyalkylene, siloxane or flurorinated groups. Hydrocarbon groups may consist of 1-30 carbons that may be linear, cyclic, branched, saturated or unsaturated. Silicone and fluorinated groups may consist of 1-50 repeat units. R substitution on the polyol may be a distribution with an average degree of substitution when total substitution is not complete. The number and size of the solvent compatible groups used for a given polyol is important for optimized performance. Too large and/or too many solvent compatibility groups can lead to various unwanted properties such as too high a solubility profile in the solvent, too high a molecular weight leading to molecule inefficiency and potentially the materials becoming a solid making solubiliztion in the solvent and formulation difficulty. Too few and/or too small solvent compatible groups can lead to reduced performance of the polyol due to poor solubility in the solvent.

The present invention polyol based surfactants may comprise one or more polyalkylene oxide units within the structure. EO/PO/BO and higher materials are alkoxy moieties, preferably selected from ethoxy, propoxy, butoxy and mixed EO/PO, EO/BO. PO/BO, EO/PO/BO groups wherein the number of repeat units (m) may consist of 1-50 units. The alkoxy moieties may be either a distribution or with an average degree of alkoxylation being corresponding to m or it may be a single specific chain with an alkoxylation number exactly corresponding to m. Placement of the alkoxy moieties in the stucture may be near the polyol moiety or on the ends on the R units.

The following general example of ethoxylated sucrose is shown below:

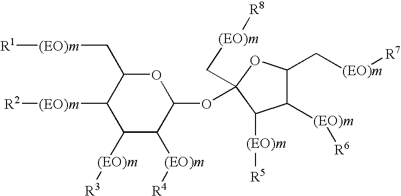

R¹, R², R³, R⁴, R⁵, R⁶, R⁷, and R⁸ can be any combination of H, hydrocarbon, polyoxyalkylene, siloxane or flurorinated groups. The method of functionalizing the polyol may be, but not limited to esterification, etherification, amidation and other linking chemistries.

In one embodiment of the present invention, the functionalized polyol has an average of at least 1 solvent compatibility group per molecule. In another embodiment of the invention, the polyol has an average of at least 2 solvent compatibility groups per molecule (twin tail), while in another embodiment the polyol has an average of from about 3 to about 8 solvent compatibility groups per molecule.

In one embodiment of the present invention, the functionalized polyol has an average of at least 20H groups per molecule. In another embodiment of the invention, the polyol has an average of at least 30H groups per molecule, while in another embodiment the polyol has an average of from about 3 to about 80H groups per molecule.

In one embodiment of the present invention, the functionalized polyol may have the 2 or more hydroxyls replaced with 1 or more of the following groups or combinations of groups: sulfate, sulfonate, carboxylate, amine, alkanolamine, phosphate and amide containing moieties. The polyol may be transesterified for example with methyloleate on several of the hydroxyl groups. The oleate esters of the polyol then become “capping” groups.

The following structures exemplify polyol containing surfactants useful in the present invention:

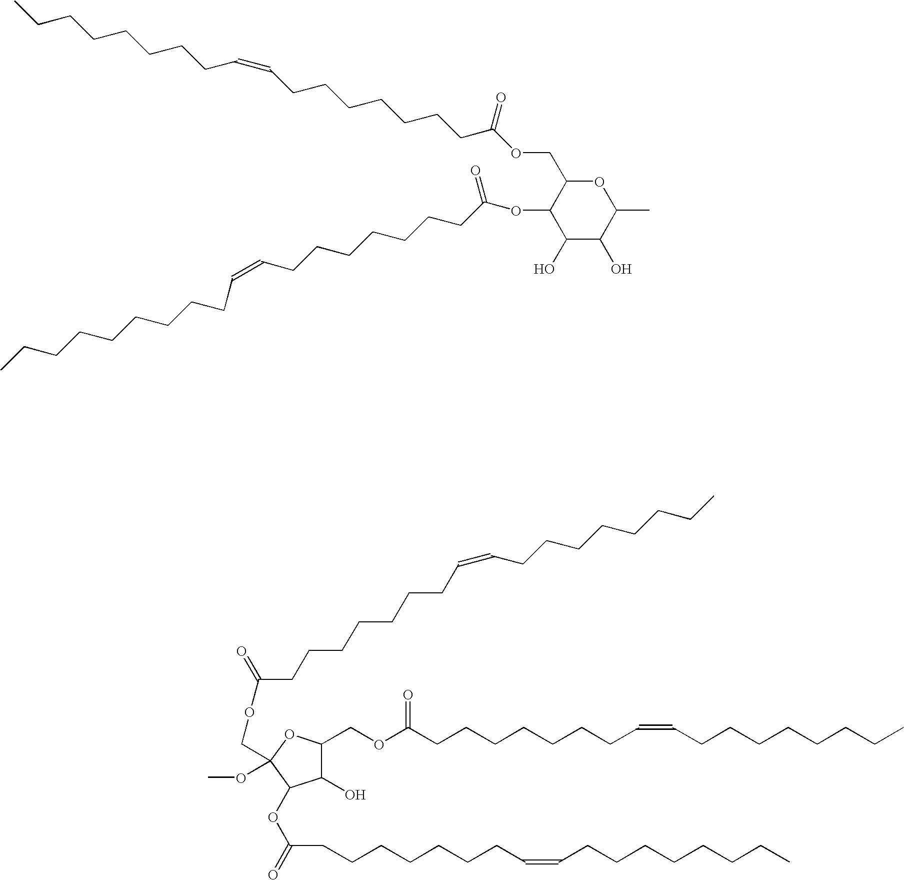

Sucrose ester from soybean oil (mainly oleyl). Solvent compatibility groups a distribution across hydroxyls and above structure a representation only.

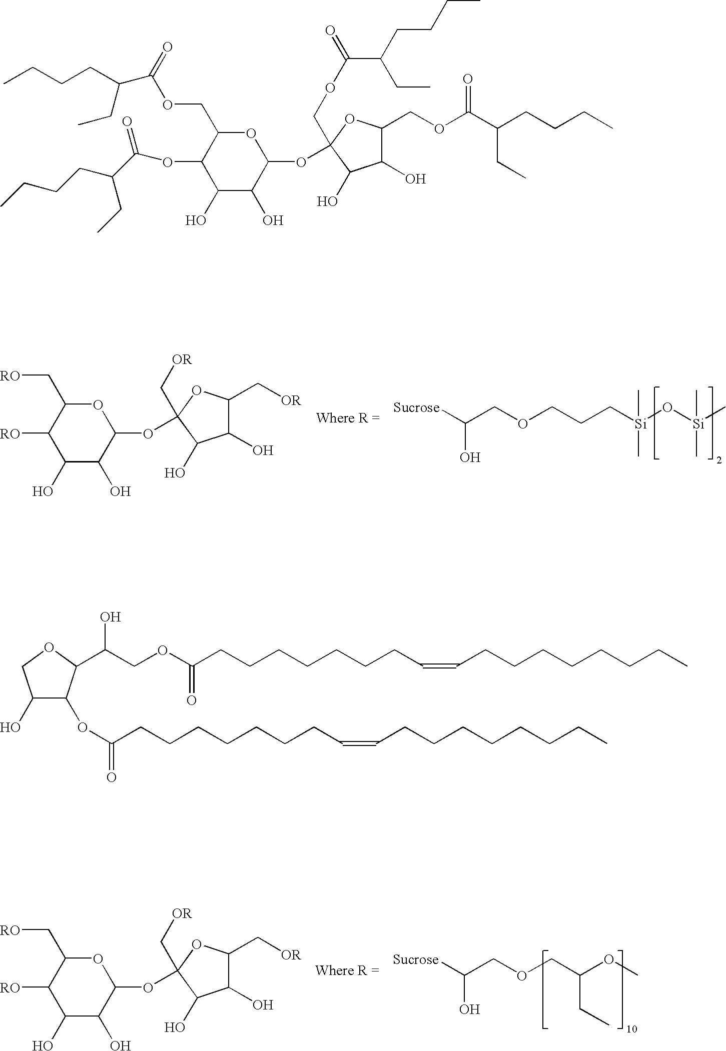

The polyol based surfactants of the present invention have at least 2 free hydroxyls per molecule, more preferably higher as long as solvent compatibility is maintained.

The polyol based surfactants of the present invention have at least one compatibility group per molecule, more preferably the minimum number needed to maintain solvent compatibility.

The polyol based surfactants of the present invention have R groups which are unsaturated or branched hydrocarbons ranging from 6 to 30 total carbons, more preferably from 8 to 18 carbons.

The polyol based surfactants are present in the cleaning formulations of the present invention at levels from 0.001% to 10%, more preferably from about 0.01% to 2%.

In one embodiment, the hydrophobic surfactant comprises one or more of the following structures:

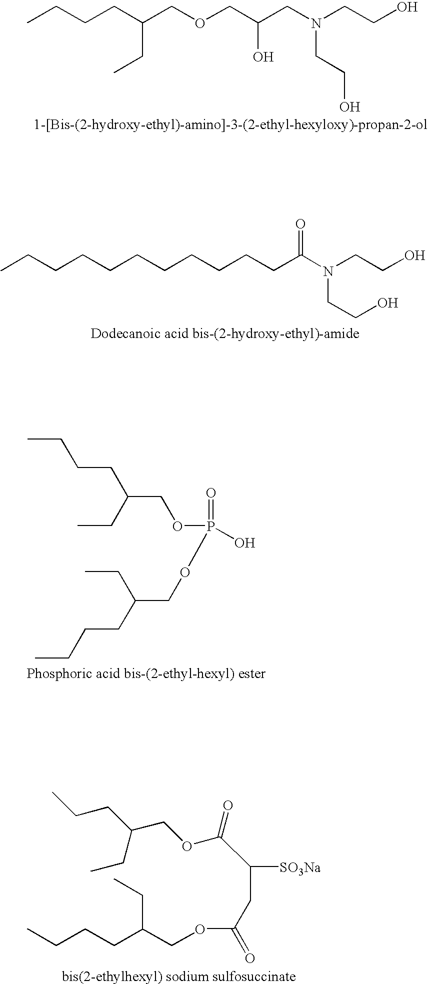

Optional Ingredients

Carrier Solvents

“Carrier solvents” as used herein means a solvent that is selected from the group consisting of: silicone solvents, hydrofluoroether solvents, perfluorinated solvents, hydrocarbon solvents, halogenated hydrocarbons, and mixtures thereof.

Cleaning Adjuncts

The compositions of the present invention may optionally comprise at least one cleaning adjunct. The cleaning adjuncts can vary widely and can be used at widely ranging levels. For example, detersive enzymes such as proteases, amylases, cellulases, lipases and the like as well as bleach catalysts including the macrocyclic types having manganese or similar transition metals all useful in laundry and cleaning products can be used herein at very low, or less commonly, higher levels. Cleaning adjuncts that are catalytic, for example enzymes, can be used in “forward” or “reverse” modes, a discovery independently useful from the fabric treating methods of the present invention. For example, a lipolase or other hydrolase may be used, optionally in the presence of alcohols as cleaning adjuncts, to convert fatty acids to esters, thereby increasing their solubility in the lipophilic fluid. This is a “reverse” operation, in contrast with the normal use of this hydrolase in water to convert a less water-soluble fatty ester to a more water-soluble material. In any event, any cleaning adjunct must be suitable for use in combination with a lipophilic fluid in accordance with the present invention.

Some suitable cleaning adjuncts include, but are not limited to, builders, surfactants, other than those described above with respect to the surfactant component, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, polymer dispersants, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters and mixtures thereof.

Suitable odor control agents, which may optionally be used as finishing agents, include agents include, cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Perfumes and perfumery ingredients useful in the compositions of the present invention comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Such materials are those precursors or mixtures thereof capable of chemically reacting, e.g., by hydrolysis, to release a perfume, and are described in patents and/or published patent applications to Procter and Gamble, Firmenich, Givaudan and others.

Bleaches, especially oxygen bleaches, are another type of cleaning adjunct suitable for use in the compositions of the present invention. This is especially the case for the activated and catalyzed forms with such bleach activators as nonanoyloxybenzenesulfonate and/or any of its linear or branched higher or lower homologs, and/or tetraacetylethylenediamine and/or any of its derivatives or derivatives of phthaloylimidoperoxycaproic acid (PAP) or other imido- or amido-substituted bleach activators including the lactam types, or more generally any mixture of hydrophilic and/or hydrophobic bleach activators (especially acyl derivatives including those of the C₆-C₁₆ substituted oxybenzenesulfonates).

Also suitable are organic or inorganic peracids both including PAP and other than PAP. Suitable organic or inorganic peracids for use herein include, but are not limited to: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof.

One class of suitable organic peroxycarboxylic acids has the general formula:

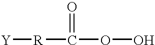

wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Particularly preferred peracid compounds are those having the formula:

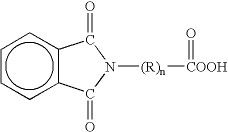

wherein R is C₁₋₄ alkyl and n is an integer of from 1 to 5. A particularly preferred peracid has the formula where R is CH₂ and n is 5 i.e., phthaloylamino peroxy caproic acid (PAP) as described in U.S. Pat. Nos. 5,487,818, 5,310,934, 5,246,620, 5,279,757 and 5,132,431. PAP is available from Ausimont SpA under the tradename Euroco.

Hydrogen peroxide is a highly preferred bleaching agent.

Other cleaning adjuncts suitable for use in the compositions of the present invention include, but are not limited to, builders including the insoluble types such as zeolites including zeolites A, P and the so-called maximum aluminum P as well as the soluble types such as the phosphates and polyphosphates, any of the hydrous, water-soluble or water-insoluble silicates, 2,2′-oxydisuccinates, tartrate succinates, glycolates, NTA and many other ethercarboxylates or citrates; chelants including EDTA, S,S′-EDDS, DTPA and phosphonates; water-soluble polymers, copolymers and terpolymers; soil release polymers; optical brighteners; processing aids such as crisping agents and/fillers; anti-redeposition agents; hydrotropes, such as sodium, or calcium cumene sulfonate, potassium napthalenesulfonate, or the like, humectant; other perfumes or pro-perfumes; dyes; photobleaches; thickeners; simple salts; alkalis such as those based on sodium or potassium including the hydroxides, carbonates, bicarbonates and sulfates and the like; and combinations of one or more of these cleaning adjuncts.

One particularly preferred class of cleaning adjuncts is additives comprising a strongly polar and/or hydrogen-bonding head group, further enhances soil removal by the compositions of the present invention. Examples of the strongly polar and/or hydrogen-bonding head group are alcohols, carboxylic acids, sulfates, sulphonates, phosphates, phosphonates, and nitrogen containing materials. Preferred additives are nitrogen containing materials selected from the group consisting of primary, secondary and tertiary amines, diamines, triamines, ethoxylated amines, amine oxides, amides, betaines, quaternary ammonium salts, and mixtures thereof. Most highly preferred materials are amino-functional siloxanes, having one or more of the following properties: i) at least about 60% by weight silicone content; and ii) alkyleneoxy groups, most preferably ethyleneoxy groups.

The compositions of the invention can be formulated as a liquid, a thickened aqueous liquid, a semi-solid or gel, or a solid product form. The thickened liquid product form can be manufactured by incorporation of a thickening agent. Inorganic thickeners typically comprise clays, silicates and other well known inorganic thickeners. Organic thickeners include thixotropic and non-thixotropic thickeners. Preferred thickeners have some substantial proportion of water solubility to promote easy removability. Examples of useful soluble organic thickeners for the compositions of the invention comprise carboxylated vinyl polymers such as polyacrylic acids and sodium salts thereof, ethoxylated cellulose, polyacrylamide thickeners, xanthan thickeners, guargum, sodium alginate and algin by-products, hydroxy propyl cellulose, hydroxy ethyl cellulose and other similar aqueous thickeners that have some substantial proportion of water solubility.

A hardening agent, as used in the present method and compositions, is a compound or system of compounds, organic or inorganic, that significantly contributes to the uniform solidification of the composition. Preferably, the hardening agent is compatible with the active ingredients of the composition, and is capable of providing an effective amount of hardness to the processed composition. The hardening agent should also be capable of forming a homogeneous matrix with the ingredients when mixed and solidified to provide a uniform dissolution of the cleaning agent from the solid composition during use. The amount of hardening agent included in the cleaning composition will vary according to the type of cleaning composition being prepared, the ingredients of the composition, the intended use of the composition, the quantity of dispensing solution applied to the solid composition over time during use, the temperature of the dispensing solution, the hardness of the dispensing solution, the physical size of the solid composition, the concentration of the other ingredients, the concentration of the cleaning agent in the composition, and other like factors. It is preferred that the amount of the hardening agent is effective to combine with the cleaning agent and other ingredients of the composition to form a homogeneous mixture under continuous mixing conditions and a temperature at or below the melting temperature of the hardening agent. The hardening agent can form a matrix with the cleaning agent and other ingredients which will harden to a solid form under ambient Another preferred hardening agent is a polyethylene glycol (PEG) or propylene glycol compound for use in a cleaning composition comprising a nonionic surfactant cleaning agent, such as a nonyl phenol ethoxylate, a linear alkyl alcohol ethoxylate, an ethylene oxide/propylene oxide block copolymers such as the surfactants available commercially under the trademark PLURONIC® from BASF-Wyandotte. The solidification rate of cleaning compositions comprising a polyethylene glycol hardening agent made according to the invention will vary, at least in part, according to the amount and the molecular weight of the polyethylene glycol added to the composition.

The hardening agent may also be a hydratable substance such as an anhydrous sodium carbonate, anhydrous sodium sulfate, or combination thereof. A hydratable hardening agent, according to the invention, is capable of hydrating to bind free water present in a liquid detergent emulsion to the extent that the liquid emulsion becomes hardened or solidified to a homogenous solid. The amount of a hydratable substance included in a detergent composition processed according to the invention, will vary according to the percentage of water present in the liquid emulsion as well as the hydration capacity of the other ingredients.

Other hardening agents that may be used in a cleaning composition processed according to the invention include, for example, urea, also known as carbamide, starches that have been made water-soluble through an acid or alkaline treatment process, and various inorganics that impart solidifying properties to a heated liquid matrix upon cooling.

The cleaning adjunct(s) preferably comprise(s) from about 0.01% to about 10%, more preferably from about 0.02% to about 7%, even more preferably from about 0.05% to about 5% by weight of the composition.

Methods

The fabric article treatment composition may be applied to a stain, preferably a hydrophilic stain, on a fabric article in need of treatment by any suitable means known in the art.

Nonlimiting examples of such methods of application include spraying, dipping, brushing, rolling and/or spreading.

With regard to the manner of using the spot pretreatment compositions, said compositions are typically used for the direct treatment of a soil or stained region of a textile or garment. In accordance with one aspect of the process according to the invention, a soiled garment is treated by applying an effective amount of the spot pretreatment composition directly at the location of a stain and optionally onto the surrounding area of the stain. This can be done in one or more of the following ways. One way is simply by means of manually dispensing an effective amount of the spot pretreatment composition directly from a container or vessel directly to the location of the stain. To make such a manual application convenient for the consumer, a number of devices may be used. For example, the spot pretreatment composition may be provided in a spray bottle having a manually operated pump, squeeze bottle, aerosol, or other dispensing container. Such containers are known to the art. In such a way, localized application of the spot pretreatment composition is facilitated and simplified by the requisite operation of the pump of the spray bottle, or by squeezing the squeeze bottle to dispense an amount of the spot pretreatment composition, or by spraying the cleaning composition from the pressurized aerosol container containing the composition according to the invention. A further particularly useful, known art dispensing apparatus is that of a container having a liquid permeable applicator tip or end, such as a porous sponge or porous fabric applicator tip. In use, a removable cap covering the applicator tip is withdrawn, the container inverted to allow the flow of the container's contents to impregnate the permeable applicator tip and the tip is then manually contacted with the stain to both transfer an amount of the spot pretreatment composition, and at the same time to manually agitate or abrade the textile or garment at the locus of the stain and optionally in the surrounding region. Such manually applied agitation provides a mechanical action which acts to physically break up the stain. This is particularly useful for stains which have been left untreated for an extended period of time, i.e., days, weeks, and longer periods, and may have hardened. Such manual agitation, provides in addition to the mechanical loosening of the stain, further acts to improve the penetration of the spot pretreatment composition throughout and among the stained fibers. Such mechanical action also improves the overall stain removal characteristics of the spot pretreatment composition. Due to these beneficial characteristics, containers having a liquid permeable applicator tip or end is particularly preferred, and such containers are known to the art.

Typically, depending on the concentration of the surfactant blend used, the pre-treatment can be contacted with the stains for about 10 to about 600 seconds, preferably about 20 to about 300 seconds. Typically, the material is sprayed or physically contacted with the soiled item. In the case of the use of a liquid material, common spray, nebulizer, or other equivalent that can apply the liquid material directly to the stain or spot can be used. In using the gel or solid formulations of the invention, the solid gel, block or stick can be directly contacted with the stain or spot leaving the solid formulation in the form of a thin film or residue substantially covering the entirety of any spot or stain on the garment. The pre-treated garment can be left to permit the surfactant compositions of the formulation to associate with the stain to pre-treat the stain or spot outside the washing machine.

In another embodiment, fabric articles within a fabric article treating apparatus may initially be contacted by a fabric article treatment composition according to the present invention and then subsequently contacted with a discrete lipophilic fluid. This process may all occur in a hands-free manner within the apparatus itself.

In another embodiement, the method comprises the steps of:

a. contacting a fabric article in need of treatment with a fabric article treatment composition inside a fabric article treating apparatus such that a stain on the fabric article is pretreated; and

b. subsequently contacting the fabric article with a discrete lipophilic fluid such that the stain on the fabric article is removed and/or reduced.

The steps of contacting within the apparatus may be via automated dosing of the fabric article treatment composition and/or the discrete lipophilic fluid by the apparatus.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modification that are within the scope of this invention.

What is claimed is:

1. A fabric article treatment composition comprising:
a) a polar solvent exhibiting at least one of the following Hansen solubility parameters:
i. a fractional polar value (f_{P}) of greater than 0.02; and/or
ii. a fractional hydrogen bonding value (f_{H}) of greater than 0.10; and
b) a hydrophobic surfactant;
wherein the fabric article treatment composition is miscible in a lipophilic fluid.

2. The fabric article treatment composition according to claim 1 wherein the polar solvent exhibits a fractional polar value (f_{P}) of greater than 0.05.

3. The fabric article treatment composition according to claim 1 wherein the polar solvent exhibits a fractional hydrogen bonding value (f_{H}) of greater than 0.20.

4. The fabric article treatment composition according to claim 1 wherein the polar solvent is selected from the group consisting of: water, alcohols, glycols, polyglycols, ethers, carbonates, esters, ketones, other oxygenated solvents, amines, amides, ureas, alkanolamines, alkanolamides, phosphate esters, alkyl nitrites and mixtures thereof.

5. The fabric article treatment composition according to claim 4 wherein the polar solvent comprises from about 0% to about 50% by weight of the composition of water.

6. The fabric article treatment composition according to claim 5 wherein the polar solvent comprises from about 0.01% to about 20% by weight of the composition of water.

7. The fabric article treatment composition according to claim 4 wherein the polar solvent comprises a glycol and/or polyglycol and/or derivatives thereof.

8. The fabric article treatment composition according to claim 4 wherein the polar solvent comprises an alkoxy alcohol.

9. The fabric article treatment composition according to claim 1 wherein the composition comprises from about 2% to about 50% by weight of the composition of the hydrophobic surfactant.

10. The fabric article treatment composition according to claim 9 wherein the composition comprises from about 10% to about 30% by weight of the composition of the hydrophobic surfactant.

11. The fabric article treatment composition according to claim 1 wherein the hydrophobic surfactant exhibits an HLB value of from about 0.1 to about 12.

12. The fabric article treatment composition according to claim 11 wherein the hydrophobic surfactant exhibits an HLB value of from about 3 to about 9.

13. The fabric article treatment composition according to claim 1 wherein the hydrophobic surfactant is selected from the group consisting of: silicone-based surfactants, organosulfosuccinate surfactants, alkanolamines, alkanolamides, alcohol alkoxylates, gemini surfactants, polyhydroxy fatty acid amides, alkylhydrogen phosphates and salts thereof, saccharide derivatives and mixtures thereof.

14. The fabric article treatment composition according to claim 1 wherein the composition further comprises a cleaning adjunct and/or a lipophilic fluid.

15. The fabric article treatment composition according to claim 1 wherein the composition exhibits a flash point of greater than 37° C.

16. The fabric article treatment composition according to claim 1 further comprises a carrier solvent selected from the group consisting of: silicone solvents, hydrofluoroether solvents, perfluorinated solvents, hydrocarbon solvents, halogenated hydrocarbons, and mixtures thereof.

17. An article of manufacture comprising:
a. a container; and
b. a fabric article treatment composition according to claim 1 contained within the container.

18. A method for removing a hydrophilic stain from a fabric article in need of treatment, the method comprising contacting the hydrophilic stain with a fabric article treatment composition that is miscible in a lipophilic fluid to form a pretreated fabric article.

19. The method according to claim 18 wherein the method further comprises contacting the pretreated fabric article with a lipophilic fluid such that the hydrophilic stain is removed and/or reduced.

20. The method according to claim 18 wherein the pretreated fabric article is formed inside a fabric article treating apparatus.

21. The method according to claim 18 wherein the pretreated fabric article is formed prior to placing the fabric article inside a fabric article treating apparatus.

22. The method according to claim 18 wherein the hydrophobic fabric article treatment composition comprises:
a) a polar solvent exhibiting at least one of the following Hansen solubility parameters:
i) a fractional polar value (f_{P}) of greater than 0.02; and/or
ii) a fractional hydrogen bonding value (f_{H}) of greater than 0.10; and
b) a hydrophobic surfactant;
wherein the hydrophobic fabric article treatment composition is miscible in a lipophilic fluid.

23. The method according to claim 18 wherein the hydrophobic fabric article treatment composition comprises a lipophilic fluid.

24. A fabric article treated by the method according to claim 18.

25. A fabric article treatment composition comprising:
a) from about 50% to about 70% by weight of the fabric article treatment composition of a first polar solvent;
b. from about 10% to about 30% by weight of the fabric article treatment composition of a second polar solvent different from the first;
c. from about 10% to about 30% by weight of the fabric article treatment composition of a hydrophobic surfactant; and
d. optionally, from about 3% to about 10% by weight of the fabric article treatment composition of a dispersant polymer;
wherein the fabric article treatment composition is miscible in a lipophilic fluid.

26. The fabric article treatment composition according to claim 25 wherein the first polar comprises 3-methoxy-3-methyl-1-butanol.

27. The fabric article treatment composition according to claim 25 wherein the second polar comprises water.
